(19) United States
(12) Patent Application Publication
(10) Pub. No.: US 2002/0025471 A1
(43) Pub. Date: Feb. 28, 2002

(54) Electrially heated thermal battery

(76) Inventors: Thomas A. Velez, Huntsville, AL (US); Nicholas Shuster, Clearwater, FL (US); Terry M. Abel, Huntsville, AL (US); Juan A. Cubero, Largo, FL (US)

Correspondence Address: LOUIS L. DACHS, 1794 PALISADES DRIVE, PACIFIC PALISADES, CA, 90272, US

(21) Appl. No.: 09/921,019

(22) Filed: Aug. 2, 2001

Related U.S. Application Data
(60) Provisional application No. 60/227,743, filed on Aug. 24, 2000.

(51) Int. Cl. H01M 6/36

(52) U.S. Cl. 429/112; 429/120

(57) ABSTRACT

The invention is a thermal battery system. In detail, the battery system includes housing. A plurality of battery cells containing an electrolyte that is in a non-operating condition at ambient temperatures and in an operating at condition at elevated temperatures is mounted within the housing. A wire heating assembly is mounted within the housing for heating the electrolyte to operating temperatures, upon the application of electric power thereto. Preferably, the heating assembly comprises a plurality of heating coils wound about the battery cells.

### RELATED APPLICATIONS

This application is a continuation-in-part of co-pending provisional patent application Serial No. 60/227,743 “Electrically Heated Thermal Battery” filed Aug. 24, 2000.

### BACKGROUND OF THE INVENTION

1. Field of the Invention

The invention relates to the field of batteries and, in particular, to thermal batteries and systems for heating such batteries to operating temperatures.

2. Description of Related Art

Thermal batteries are noted for their extremely high discharge rate and power delivered for short periods of time and generally has a very long storage life. A typical prior art thermal battery comprises a plurality of cells having metallic positive electrode and a metallic negative electrode spaced apart with an inactive electrolyte that becomes electrically active when heated. A combustible material is disposed between the cells and in contact therewith for supplying heat to the electrolyte, which is actuated by an explosive squib. The combustible material is typically a mixture of a finely divided metal oxide and a finely divided metal such that it will exothermically react to form an electrically conductive oxide. Thus this material contributes greatly to the weight of the battery. Upon ignition, the combustible material heats the electrolyte to a temperature wherein it melts.

At this point, the battery will produce electrical energy, unfortunately for only a short period. Thus they have general application as a back-up power supply. In addition, they have application in non-emergency systems. On launch vehicles and spacecraft there is often a need for large amounts of electrical energy for short periods. The weight of conventional batteries would be prohibitive. However, thermal batteries weighing as low as a few pounds provide more than adequate performance. An extreme example is that two fifty pound thermal batteries providing 270 volts and 450 amperes for three minutes can replace 2500 pounds of conventional batteries. A typical thermal battery is disclosed in U.S. Pat. No. 4,041,217 “Thermal Battery With Metal Oxide Heating Composition” By W. H. Collins.

As previously mentioned, such thermal batteries are short lived. For once the heat generating chemicals are exhausted, the battery begins to cool down, and over a rather short period of time, the electrolyte becomes inactive while still having stored electrical power. However, many such batteries loose their charge, before the electrolyte becomes inactive. There have been attempts to build non-pyrotechnic heated thermal batteries; however, these used external heating enclosures to heat the entire battery assembly. Such systems would be extremely heavy and impractical for use on launch vehicles or spacecraft.

Of course, conventional battery heating systems are old in the art. For example U.S. Pat. No. 3,623,916 “Storage Battery With Heater” by T. Toyooka, et al. discloses a battery design wherein a wire heating element is incorporated into the battery casing and connected the terminals thereof in order to maintain the electrolyte at optimum temperature. Also of interest is U.S. Pat. No. 5,158,841 “High-Temperature Storage Battery” by S. Mennicke, et al., which discloses a cooling system for a battery disposed about the cells for conducting heat therefrom during periods of operation. A wire heating grid is provided at the bottom of the cells for maintaining the cells at operation temperature during non-operating periods. However, the problem with most thermal batteries is maintaining them at operating temperatures, and cooling is not an issue. The use of a heating grid at one end of the battery cells is most inefficient.

Thus, it is a primary object of the invention to provide a thermal battery that can be continuously maintained at operating temperature.

It is another primary object of the invention to provide a light weight thermal battery.

It is a further object of the invention to provide a thermal battery that can be recharged.

### SUMMARY OF THE INVENTION

The invention is a thermal battery system. In general, the battery system includes housing. Mounted with the housing are a plurality of battery cells containing an electrolyte that is in a non-operating condition (non-conductive) at ambient temperatures and in an operating condition (the electrolyte is conductive) at elevated temperatures. When heated, the electrolyte remains semi-ridged, but does tend to flow over time. A wire heating assembly is mounted about the plurality of battery cells for heating the electrolyte to operating temperatures, upon the application of electric power thereto. Preferably, the heating assembly comprises heating coils wound about the battery cells.

To provide efficient heating of the battery cells, the housing contains a first insulation layer mounted about the battery cells. A second ridged layer of insulation, preferably made of Mica, is mounted about the first layer of insulation extending about the battery cells with the wire heating element assembly mounted about thereabout. This ridged layer of insulation prevents any of the electrolytes from reaching and damaging the heating wires. Preferably, the wire heating assembly is made of nickel-chrome wire. A third layer of insulation is mounted about the wire assembly. If desired a charging system can be coupled across the positive and negative poles of the battery cells for re-charging the cells.

In a second preferred embodiment the thermal battery system includes a first housing with the electrical energy supplying assembly for supplying electrical power when heated to operating temperatures mounted within the first housing. A wire heating assembly is mounted about the first housing for heating the electrical energy supply assembly to operating temperatures. A second housing is mounted about the fist housing and the wire heating assembly. A first insulation layer is mounted about at least a portion of the electrical energy supplying assembly within the first housing and a second insulation layer is mounted between the first and second housings about the wire heating element assembly.

The novel features which are believed to be characteristic of the invention, both as to its organization and method of operation, together with further objects and advantages thereof, will be better understood from the following description in connection with the accompanying drawings in which the presently preferred embodiments of the invention are illustrated by way of examples. It is to be expressly understood, however, that the drawings are for purposes of illustration and description only and are not intended as a definition of the limits of the invention.

### BRIEF DESCRIPTION OF THE DRAWINGS

FIG. 1 is a cross-sectional of the thermal battery.

FIG. 2 is a cross-sectional view of FIG. 1 taken along the line 2-2.

FIG. 3 is a cross-sectional view of battery cell.

FIG. 4 is a cross-sectional view of a second embodiment of the thermal battery.

### DESCRIPTION OF THE PREFERRED EMBODIMENT

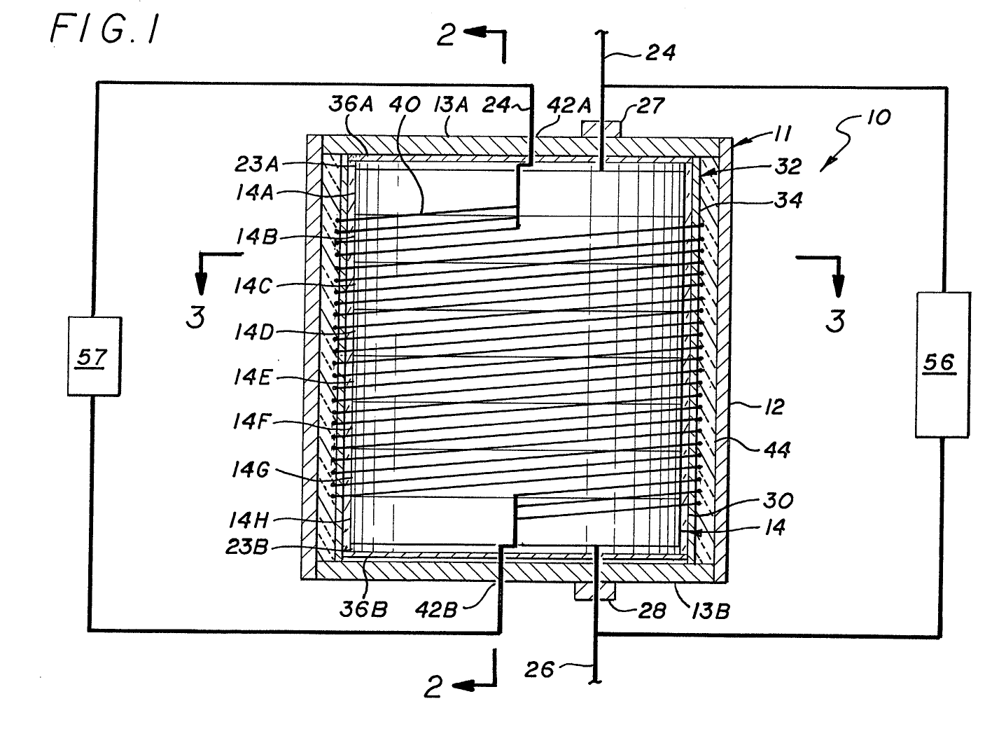

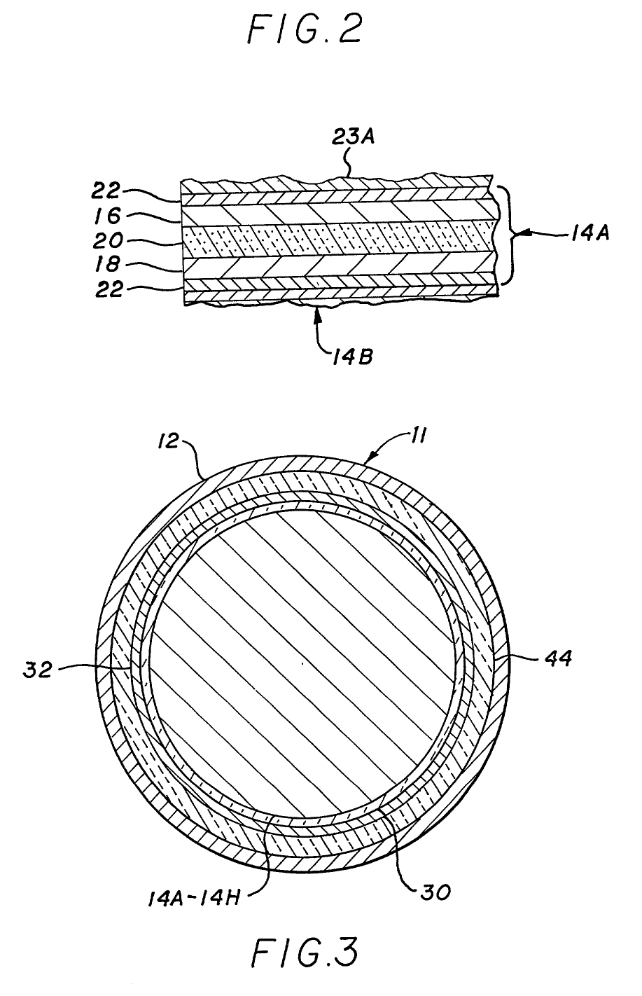

Illustrated in FIG. 1 is a thermal battery assembly, generally indicated by numeral 10, comprising a hermetically sealed circular container 11 having a side wall 12 and top and bottom covers 13A and 13B. A battery 14 made up of a plurality of cells 14A, B, C, D, E, F, G, H. Referring to FIG. 2 each cell, for example cells 14B and 14C, comprise a cathode 16, anode 18, solid electrolyte 20 and conductive spacers 22. A typical cathode 16 will be made of a material such as iron pyrite (iron disulfide, FeS₂), a typical anode 18 will be made from a material such as a lithium -silicon alloy, the spacers 22 will be made from stainless steel alloy, while the electrolyte 20 is made of a mixture of alkali halide salts. Of course, there are numerous other combinations of materials. The actual chemical makeup of the cells is not a critical to the invention; thus the cell structure need not be discussed in further detail.

Referring back to FIG. 1, the cells are connected in series by the conductive spacers 22. Non conductive spacers 23A and 23B further insulate the battery cells 14A-14H from the top and bottom covers 13A and 13B of the housing 11. Lead wires 24 and 26 connect the cells 14A-14H to connectors 27 and 28 mounted in the in the top and bottom covers 13A and 13B, respectively, of the housing 11. These lead wired 24 and 26 also extend through holes (not shown) in the spacers 23A and 23B and top and bottom covers 36A and 36B, respectively, of the container 32.

The plurality of battery cells 14A-4H are placed under compression and wrapped with an inner flexible high temperature insulation layer 30. A suitable high temperature insulation material is Fiberflax® manufactured by Unifrax Corporation, Niagara Falls, N.Y. A ridged container 32, having a side wall 34 and top and bottom walls 36A and 36B, is positioned about the wrapped stack 14A-14H made of quartz like material such as mica. Heating element 40, preferably made of nichrome wire, is wrapped about the side wall 34 of the container 32 and is connected to terminals 42A and 42B in the top and bottom covers 13A and 13B, respectively, of the container 11. Additional flexible high temperature insulation layers 44 are wrapped about the heating element 40. Electrical lead 46 and 48 connect to terminals 50 and 52, respectively, on the top and bottom covers 13A and 13B. Finally, battery-charging circuit 56 can be coupled to the terminals 27 and 28 for charging the battery assembly. In addition, a heater control system 57 is provided to control the heating level of the battery 14

Thus electrical power source (not shown) is coupled to connectors 42A and 42B, the electrolyte is heated until it becomes active. The battery is then active and can supply very large amounts of power for a short period of time. After it is discharged, but still at high temperature, battery charger 56 can recharge it. Even after the battery has been allowed to cool to a point that the electrolyte is non-conductive, the heating wires can be activated and the charger 56 used to recharge. Thus not only is thermal battery reusable, but the elimination of the pyrotechnics used for heating in the prior art designs is eliminated.

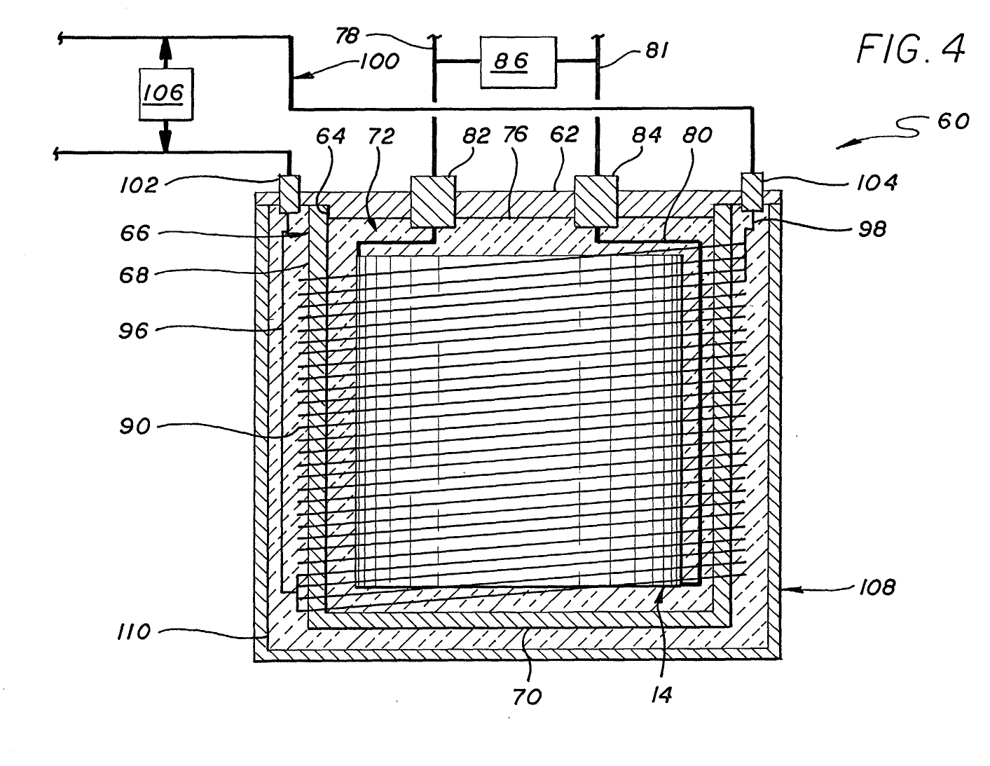

FIG. 4 presents a second embodiment of the invention. The thermal battery assembly, generally designed by numeral 60, includes a top plate 62 having a circular protrusion or boss 64. A circular metal cup 66 having a side wall 68 and bottom wall 70 is joined by its open end 72 to the boss 64. The cup 66 maybe joined to the boss 64 by any number of conventional joining techniques, such as by welding. Mounted generally within the center of the cup 66 is the previously mentioned battery 14 surrounded by insulation 76. Lead wires 78 and 80 connect the battery 14 to an external circuit 81 via connectors 82 and 84, respectively, mounted in the in the top plate 62. The external circuit 81 is coupled to a battery charging circuit 86.

A heating element 90, preferably made of nichrome wire, is wrapped about the side wall 68 of the cup 66. Lead wires 96 and 98 connect to external circuit assembly 100 via connectors 102 and 104, respectively, mounted in the top plate 62. The circuit assembly 100 includes a power supply assembly 106. A second cup shaped member 108 is mounted about the heating element 90 and cup 62 and is also joined to the top plate 62. The space between the two cups 62 and 108 is also filed with insulation 110, between the housing 66 and heating element 90 and between the heating element and second cup shaped member 108. Operation is similar to a normal thermal battery.

The advantage of this second battery assembly 60 is that the use of a metal cup 66 insures that none of the heated electrolyte can reach the heating wire element 90 causing damage thereto. In addition, the design has far more structural integrity.

While the invention has been described with reference to particular embodiments, it should be understood that the embodiments are merely illustrative, as there are numerous variations and modifications, which may be made by those skilled in the art. Thus, the invention is to be construed as being limited only by the spirit and scope of the appended claims.

Industrial Applicability

The invention has applicability to the battery manufacturing industry.

1. A thermal battery system comprising:
a housing;
an electrical energy supplying assembly for supplying electrical power when heated to operating temperatures mounted within said housing
a wire heating assembly mounted within said housing for heating said electrical energy supply assembly to operating temperatures.

2. The thermal battery system as set forth in claim 1 further comprising said housing containing a first insulation layer mounted about said at least a portion of said electrical energy supplying assembly.

3. The thermal battery system as set forth in claim 2 further comprising said wire heating element assembly mounted within said insulation layer.

4. The thermal battery system as set forth in claim 1, or 2, or 3, further including means to adjust the level of heating produced by said wire heating assembly.

5. The thermal battery system as set forth in claim 4 wherein said wire heating assembly is made of nickel-chrome wire.

6. The thermal battery system as set forth in claim 5 comprising:
a second ridged insulation layer mounted within said first insulation layer; and
said wire-heating assembly mounted about at least a portion of said second ridged insulation layer.

7. The thermal battery system as set forth in claim 6 further including means coupled to said electrical energy supplying assembly for recharging same.

8. A thermal battery system comprising:
a first housing;
an electrical energy supplying assembly for supplying electrical power when heated to operating temperatures mounted within said first housing;
a wire heating assembly mounted about said first housing for heating said electrical energy supply assembly to operating temperatures; and
a second housing mounted about said fist housing and said wire-heating assembly.

9. The thermal battery system as set forth in claim 8 further comprising said first housing containing a first insulation layer mounted about said at least a portion of said electrical energy supplying assembly.

10. The thermal battery system as set forth in claim 9 further comprising a second insulation layer mounted between said first and second housings about said wire heating element assembly.

11. The thermal battery system as set forth in claim 8, or 9, or 10, further including means to adjust the level of heating produced by said wire heating assembly.

12. The thermal battery system as set forth in claim 11 wherein said wire heating assembly is made of nickel-chrome wire.

13. The thermal battery system as set forth in claim 12 further including means coupled to said electrical energy supplying assembly for recharging it.
